(19) United States
(12) Patent Application Publication
(10) Pub. No.: US 2018/0112083 A1
(43) Pub. Date: Apr. 26, 2018

(54) CYLINDRICAL TUBE WHOSE INNER WALL IS CONSTITUTED BY A HYDROPHOBIC COATING

(71) Applicant: SAINT-GOBAIN PERFORMANCE PLASTICS FRANCE, Chamy Oree de Puisaye (FR)

(72) Inventors: Pascaline HAYOUN, Philadelphia, PA (US); Alban LETAILLEUR, Paris (FR); Jeremie TEISSEIRE, Antony (FR); Etienne BARTHEL, Bourg-la-Reine (FR); Francois LEQUEUX, Paris (FR); Emilie VERNEUIL, Paris (FR)

(21) Appl. No.: 15/793,619

(22) Filed: Oct. 25, 2017

(30) Foreign Application Priority Data
Oct. 25, 2016 (FR) 1660347
Oct. 25, 2016 (FR) 1660348
Dec. 20, 2016 (FR) 1662846

(51) Int. Cl. C09D 5/16; C09D 7/62; C09D 7/40; C09D 7/65; C08K 3/36; C08K 5/5419; C08J 7/12; C08J 7/04; B05D 7/02; B05D 7/22; B05D 5/08; B05D 3/14

(52) U.S. Cl. CPC C09D 5/1681; C09D 7/62; C09D 7/68; C09D 7/65; C08K 3/36; C08K 5/5419; B05D 2254/04; C08J 7/04; B05D 7/02; B05D 7/22; B05D 5/083; B05D 3/148; C08J 7/123

(57) ABSTRACT

The invention relates to a cylindrical tube made of polymer material or glass, whose cylindrical inner wall includes a coating of hydrophobic particles having a surface with a peak-to-valley distance of between 100 nm and 50 μm;
a process for manufacturing said tube by forming a coating on its inner wall including the steps of
displacing a segment of a liquid composition of suspended coating particles within the tube at a constant controlled velocity of at least 2 cm/sec so as to drive a homogeneous liquid film on the inner wall of the tube,
letting the solvent of the liquid composition evaporate and the suspended coating particles deposit on the inner wall of the tube,
optionally, repeating the two previous steps at least once.

### CROSS-REFERENCE TO RELATED APPLICATION(S)

This application claims priority under 35 U.S.C. § 119(a) to, and incorporates herein by reference in its entirety for all purposes, French application FR1660347, filed Oct. 25, 2016, entitled “PROCESS FOR COATING THE INNER WALL OF A TUBE,” to Pascaline HAYOUN et al. and which is assigned to the current assignee hereof. This application also claims priority under 35 U.S.C. § 119(a) to, and incorporates herein by reference in its entirety for all purposes, French application FR1660348, filed Oct. 25, 2016, entitled “METHOD FOR COATING THE INNER WALL OF A TUBE,” to Pascaline HAYOUN et al. and which is assigned to the current assignee hereof. This application also claims priority under 35 U.S.C. § 119(a) to, and incorporates herein by reference in its entirety for all purposes, French application FR1662846, filed Dec. 20, 2016, entitled “CYLINDRICAL TUBE WHOSE INNER WALL IS CONSTITUTED BY A HYDROPHOBIC COATING,” to Pascaline HAYOUN et al. and which is assigned to the current assignee hereof.

### FIELD OF THE DISCLOSURE

This disclosure, generally, is related to a tube and a coating for the inner wall of the tube.

### BACKGROUND

Many industries circulate liquids in cylindrical tubes, such as tubes made from a polymer material, or even in glass or metal, whether intended for the distribution of water or food (coffee, soup dispenser, etc.), or for medical (perfusion, etc.) applications. These cylindrical tubes have, for example, an internal diameter at most equal to 20 or even 15 mm, and at least equal to 1 mm.

This circulation of liquids generally induces a change in the surface state of the inner wall of the tube: droplets are liable to remain in adhesion with the wall after passage of an amount of liquid in the tube and then to leave, after evaporation, a slight solid deposit creating a surface irregularity likely to retain other droplets during a subsequent passage of liquid into the tube.

It is therefore advantageous to be able to coat the inner wall of a cylindrical tube with a hydrophobic or superhydrophobic layer having the effect of reducing or suppressing the attachment of droplets when an amount of liquid is passing through it: a hydrophobic layer modifies the surface tension of the inner wall of the tube. This hydrophobic layer should have a good adhesion with the inner wall of the tube, and be durable, such that it keeps its initial quality during the passage of the greatest possible quantities of liquid. In particular, there is a need for tubes whose inner wall has a contact angle with water as high as 135°, or even 150°.

This hydrophobic layer should be as regular as possible in thickness, composition, morphology and appearance over the entire surface of its deposit. Its formation process should be compatible with the material of the tube, in particular, a polymer.

### SUMMARY

In an embodiment, the invention relates to a cylindrical tube made of polymeric material or glass, characterized in that its cylindrical inner wall is constituted by a coating of hydrophobic particles, the surface of which has a peak-to-valley distance of between 100 nm and 50 μm, such as between 0.3 and 20 μm.

### DETAILED DESCRIPTION

The following description in combination with the figures is provided to assist in understanding the teachings disclosed herein. The following discussion focuses on specific implementations and embodiments of the teachings. This focus is provided to assist in describing the teachings and should not be interpreted as a limitation on the scope or applicability of the teachings. As used herein, the terms “comprises,” “comprising,” “includes,” “including,” “has,” “having” or any other variation thereof, are open-ended terms and should be interpreted to mean “including, but not limited to . . . . ” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at room temperature, such as about 77° F. (25° C.). For instance, values for viscosity are at 77° F. (25° C.), unless indicated otherwise.

In an embodiment, the invention relates to a cylindrical tube made of a polymeric material or glass, characterized in that its cylindrical inner wall is constituted by a coating of hydrophobic particles, the surface of which has a peak-to-valley distance of between 100 nm and 50 μm, such as between 0.3 and 20 μm.

Cylindrical inner walls of tubes having contact angles with water of at least 135°, and even 150°, have thus been obtained.

For the purposes of the invention, the term “cylindrical tube” is understood to mean a closed hollow profile whose cross-sections of the outer and inner walls essentially describe two circles that are not necessarily concentric.

The tube of the invention may be flexible, made of an elastic material; transparent, opaque, colored, made of thermoplastic or thermosetting polymeric material, or a combination thereof; in particular embodiments, it is made of a thermoplastic polymer and includes, in a particular embodiment, polystyrene, polyester, silicone elastomer, silicone copolymer, thermoplastic silicone vulcanizate, poly(dimethylsiloxane), copolyester, polyamide, fluoropolymer, fluoroelastomer, polyethylene, polypropylene, polyether-ester copolymer, thermoplastic urethane, polyether amide block copolymer, polyamide copolymer, block copolymer of styrene, polycarbonate, polyolefin elastomer, natural rubber, nitrile rubber, thermoplastic vulcanizate, ionomer, polyoxymethylene, acrylonitrile butadiene styrene, acetal, acrylic, polyvinyl chloride, or a combination thereof.

The peak-to-valley distance is that between the altitude of the highest altitude point and that of the lowest altitude point on the inner wall of the tube. It is determined by interference profilometer, or by AFM (Atomic Force Microscope) for relatively small peak-to-valley distances, at most equal to 10 μm.

According to exemplary embodiments of the tube of the invention, the tube may include one or more of the following features:
the inside diameter of the tube is at most equal to 10 cm, such as, for example, 5 cm, 20 mm, 10 mm, and 4 mm;
the inside diameter of the tube is at least equal to 1 mm;
the coating of hydrophobic particles has a thickness at least equal to 300 nm;
the hydrophobic particles are chosen from metal oxide particles such as silica bearing a hydrophobic coating, hydrophobic polymer particles such as fluoropolymer, polysiloxane, polystyrene, polyester, silicone copolymer, silicone thermoplastic vulcanizate, copolyester, polyamide, polyethylene polypropylene, polyether-ester copolymer, thermoplastic polyurethane, polyether amide block copolymer, polyamide copolymer, styrene block copolymer, polycarbonate, polyolefin elastomer, thermoplastic vulcanizate, ionomer, polyoxymethylene (POM), acrylonitrile butadiene styrene (ABS), acetal, acrylic, polyvinyl chloride (PVC), or a combination thereof;
metal oxide particles such as silica bearing a hydrophobic coating may be obtained by grafting an R—Si—X3 coupling agent where R is selected from an alkyl, aryl, siloxane, fluoroalkyl group, and X is a halide or an alkoxy group, or else obtained by adsorption of a polysiloxane or of a fluoropolymer at the surface;
“fluoropolymer” is understood herein to mean a polymer having in its chain at least one monomer chosen from compounds containing a vinyl group capable of opening to polymerize or propagate a polymerization reaction and which contain, directly attached to this vinyl group, at least one fluorine atom, a fluoroalkyl group or a fluoroalkoxy group. Examples of monomers include vinyl fluoride; vinylidene fluoride (VF2); trifluoroethylene (VF3); chlorotrifluoroethylene (CTFE); 1,2-difluoroethylene; tetrafluoroethylene (TFE); hexafluoropropylene (HFP); perfluoro (alkylvinyl) ether, such as perfluoro (methyl vinyl) ether (PMVE), perfluoro (ethylvinyl) ether (PEVE) and perfluoro (propyl vinyl) ether (PPVE); perfluoro (1,3-dioxole); perfluoro (2,2-dimethyl-1,3-dioxole) (PDD); the compound of formula CF2═CFOCF2CF(CF3)OCF2CF2X wherein X is SO2F, CO2H, CH2OH, CH2OCN or CH2OPO3H; the compound of formula C CF2═CFOCF2CF2SO2F; the compound of formula F(CF2)nCH2OCF═CF2 wherein n is 1, 2, 3, 4 or 5; the compound of formula R1CH2OCF═CF2 wherein R1 is hydrogen or F(CF2)z and z is 1, 2, 3 or 4; the compound of formula R3OCF═CH2 wherein R3 is F(CF2)z- and z is 1, 2, 3 or 4; perfluorobutylethylene (PFBE); 3,3,3-trifluoropropene; 2-trifluoromethyl-3,3,3-trifluoro-1-propene. The fluoropolymer may be a homopolymer or a copolymer, it may also include non-fluorinated monomers such as ethylene. In a particular embodiment, the fluoropolymer is chosen from: fluorinated ethylene propylene (FEP), ethylene tetrafluoroethylene (ETFE), polytetrafluoroethylene perfluoropropylvinyl ether (PFA), polytetrafluoroethylene perfluoromethyl vinyl ether (MFA), polytetrafluoroethylene (PTFE), polyvinylidene fluoride (PVDF), ethylene chlorotrifluoroethylene (ECTFE), polychlorotrifluoroethylene (PCTFE), or a combination thereof;
the term “polysiloxane” is understood herein to mean rubbers having in their polymer chain silicon and oxygen, defined by “Family Q” in standard ASTM D 1418-01a, in an embodiment, the polysiloxane is polydimethylsiloxane (PDMS), with a particular embodiment, the hydrophobic coating includes fumed silica, a polydimethylsiloxane and crosslinker; the hydrophobic coating particles have a size of between 5 nm and 10 μm; such as between 500 nm and 5 μm;
the coating particles have a mono- or polydisperse size distribution; the coating which they constitute has a roughness, characterized by the above-mentioned peak-to-valley distance, which can induce a super-hydrophobic behavior as already indicated;
the inner wall has a contact angle with water of at least 135°, such as 150°.

The invention also relates to a method forming a coating on the inner wall of a tube, including the steps of
moving a segment of a liquid composition of coating particles in suspension within the tube at a constant controlled velocity at least equal to 2 cm/s, so as to drive a homogeneous liquid film on the inner wall of the tube, and
letting the solvent of the liquid composition evaporate and the suspended coating particles settle on the inner wall of the tube,
optionally, repeating the two preceding steps at least once.

This method makes it possible to deposit layers that are substantially uniform, or even perfectly uniform, in thickness and homogeneous, durable and of good adhesion with the cylindrical inner wall of the tube. It does not involve any heat treatment and is in no way liable to degrade the material (polymer, etc.) of the tube.

In order to move the liquid segment in the tube at constant controlled velocity, it is possible to place the tube vertically and connect the upper end to a reserve of the liquid composition via a valve or, optionally, to close one end of the tube in the vicinity of which the latter contains a reasonable quantity of coating liquid, which is then connected to a pressure above atmospheric pressure via a valve.

A substantially uniform, or even perfectly uniform, film of the liquid coating composition is first deposited on the inner wall of the tube and then the solvent of this composition evaporates leaving the coating particles deposited in good adhesion with the inner wall of the tube. Insofar as these particles are in a homogeneous concentration throughout the initial liquid composition, the thickness of the coating of particles obtained is also substantially constant macroscopically. Depending on the shape of the particles and the distribution of their dimensions, the coating obtained has a more or less random roughness, which can induce superhydrophobic surface behavior for hydrophobic particles.

In an embodiment, in order to allow the solvent of the liquid composition to evaporate and the suspended coating particles to settle on the inner wall of the tube, the tube is allowed to stand at room temperature for at least one hour.

In an embodiment, the static contact angle of a drop of the liquid composition of suspended coating particles on the inner wall of the tube is at most equal to 20°. The liquid coating composition leaves, by flowing at a constant velocity in the tube, a film which is substantially uniform, or even perfectly uniform, and does not strike the inner wall of the tube. The displacement velocity of the liquid coating segment can then be adjusted sufficiently high so that the fraction of the liquid film deposited in the first place does not begin to evaporate before the fraction of the liquid film deposited last is deposited.

According to other exemplary embodiments of the process of the invention, the process may include one or more of the following:
said two preceding operations are repeated until the thickness of the coating is at least equal to 300 nm or the coating has a microtexturing of between 100 nm and 50 μm;
said two preceding operations are repeated twice, that is to say performed three times in total; in many cases, this process allows achieving a desired thickness of the coating;
the displacement velocity of the liquid segment is at least equal to 5, such as 10 cm/s, and at most equal to 50 cm/s; the higher the velocity, the greater the thickness of the liquid film and the amount of particles deposited; the latter also depend on the properties of the liquid, in a particular embodiment, its viscosity;
prior to the displacement of a segment of a liquid composition inside the tube, the latter is first subjected to a treatment in order to render the surface thereof hydrophilic so that the contact angle of a drop of water is at most equal to 20°;
prior to the displacement of a segment of a liquid composition inside the tube, the latter is first subjected to a reduction of the pressure to a value at most equal to 10 mbar, and then to a plasma activation; this provision aims at increasing the adhesion of the particle coating to the inner wall of the tube; it has the effect, by creating free radicals, of oxidizing the inner wall of the tube, for example in the case of a poly(dimethylsiloxane) (PDMS) tube, of modifying the SiCH3 sites to SiOH; it includes, for example, in plugging the two ends of the tube, in making inside the tube a primary vacuum, so that the plasma can then enter into the tube, and which can be obtained by means of an Adixen® type pump of PASCAL 2005 SD model for 1.5 min, and then to carry out a plasma treatment for 15 s, for example, by implementing a high-frequency generator as marketed by Electrotechnic Products, Inc., in particular of the Tesla coil type, 50/60 Hz, 300 W;
prior to the displacement of a segment of a liquid composition inside the tube, the latter is subjected to chemical activation; like the preceding, this provision also aims at increasing the adhesion of the particle coating to the inner wall of the tube; it may include a treatment with an acid or oxidizing solution;
after moving a segment of a liquid composition inside the tube, the latter is subject to a thermal treatment, such as at room temperature (25° C.) to 150° C. and in an embodiment, for a time of 10 minutes to 24 hours; this measure may increase the adhesion of the coating of particles to the inner wall of the tube.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

Embodiment 1. A cylindrical tube made of polymer material or glass includes a cylindrical inner wall that is constituted by a coating of hydrophobic particles having a surface with a peak-to-valley distance of between 100 nm and 50 μm, such as between 0.3 and 20

Embodiment 2. The tube of embodiment 1, characterized in that the inside diameter of the tube is at most equal to 10 cm, such as 5 cm, such as 20 mm, such as 10 mm. or even 4 mm.

Embodiment 3. The tube of embodiment 1, characterized in that the internal diameter of the tube is at least equal to 1 mm.

Embodiment 4. The tube of embodiment 1, characterized in that the coating of hydrophobic particles has a thickness of at least 300 nm.

Embodiment 5. The tube of embodiment 1, characterized in that the hydrophobic particles include metal oxide particles such as silica bearing a hydrophobic coating, hydrophobic polymer particles such as fluoropolymer, polysiloxane, polystyrene, polyester, silicone copolymer, thermoplastic silicone vulcanizate, copolyester, polyamide, polyethylene, polypropylene, polyether-ester copolymer, thermoplastic polyurethane, polyether amide block copolymer, polyamide block copolymer, styrene block copolymer, polycarbonate, polyolefin elastomer, thermoplastic vulcanizate, ionomer, polyoxymethylene (POM), acrylonitrile butadiene styrene (ABS), acetal, acrylic, polyvinyl chloride (PVC) or a combination thereof.

Embodiment 6. The tube of embodiment 5, wherein the hydrophobic particles include silica bearing a hydrophobic coating.

Embodiment 7. The tube of embodiment 1, characterized in that the hydrophobic coating particles have a size of between 5 nm and 10 μm, such as between 500 nm and 5 μm.

Embodiment 8. The tube of embodiment 1, characterized in that the coating particles have a mono- or polydispersed size distribution.

Embodiment 9. The tube of any one of the preceding embodiments, characterized in that the inner wall has a contact angle with water of at least 135, such as 150°.

Embodiment 10. A process for manufacturing a cylindrical tube made of polymer material or glass of embodiment 1, by forming a coating on the inner wall of the tube, including the steps of
displacing a segment of a liquid composition of suspended coating particles within the tube at a constant controlled velocity of at least 2 cm/sec so as to drive a homogeneous liquid film on the inner wall of the tube,
letting the solvent of the liquid composition evaporate and the suspended coating particles deposit on the inner wall of the tube, and
optionally, repeating the two previous steps at least once.

Embodiment 11. The process of embodiment 10, characterized in that, in order to let the solvent of the liquid composition evaporate and the suspension particles be deposited on the inner wall of the tube, the tube is allowed to stand at room temperature for at least one hour.

Embodiment 12. The process of embodiment 10, characterized in that the static contact angle of a drop of the liquid composition of suspended coating particles on the inner wall of the tube is at most equal to 20°.

Embodiment 13. The process of embodiments 10 to 12, characterized in that said two preceding operations are repeated until the thickness of the coating is at least equal to 300 nm, or the coating has a peak-to-valley distance between 100 nm and 50 μm.

Embodiment 14. The process of embodiments 10 to 13, characterized in that said two preceding operations are repeated twice.

Embodiment 15. The process of embodiments 10 to 14, characterized in that the displacement velocity of the liquid segment is at least equal to 5 cm/s.

Embodiment 16. The process of embodiment 15, characterized in that the displacement velocity of the liquid segment is at least equal to 10 cm/s.

Embodiment 17. The process of embodiments 10 to 16, characterized in that the displacement velocity of the liquid segment is at most equal to 50 cm/s.

Embodiment 18. The process of embodiments 10 to 17, characterized in that, prior to the displacement of a segment of a liquid composition inside the tube, it is first subjected to a treatment to render its surface hydrophilic so that the contact angle of a drop of water is at most equal to 20°.

Embodiment 19. The process of embodiment 18, characterized in that, prior to the displacement of a segment of a liquid composition inside the tube, it is first subjected to a reduction of the pressure to a value at most equal to 10 mbar, and then to a plasma activation.

Embodiment 20. The process of embodiment 18, characterized in that, prior to the displacement of a segment of a liquid composition inside the tube, the latter is subjected to chemical activation.

The concepts described herein will be further described in the following examples, which do not limit the scope of the disclosure described in the claims. The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

### Example 1

The inner wall is coated with an extruded polyethylene (PE) tube having a 1.5 m length, a 8.4 mm outer diameter and a 6.4 mm internal diameter, by means of a solution marketed by Soft99 Co. Japan under the trade name Glaco Mirror Coat “Zero.”

The tube is in a vertical position.

The abovementioned solution contains 85 to 90% by weight of isopropanol, 0.1 to 3% by weight of hydrophobic treated silica particles and 10 to 15% by weight of a mixture of liquefied propane, n-butane and i-butane. The size distribution of the silica particles is monodispersed; the average particle size is 127.7 nm.

The viscosity of the solution is 2.3 mPa·s (or cP) measured with a “Low shear 400” rheometer marketed by Lamy Rheology, operating in simple shear in a quilt geometry at 25 ° C.

The upper end of the tube is connected to a reservoir of the suspended coating particle solution via a valve; the displacement velocity of the liquid in the tube is constantly 20 cm/s. After the passage of a quantity of liquid through the tube, the latter is left at room temperature for 1 hour.

The passage through the tube of an amount of this liquid, followed by one hour at rest at room temperature, is repeated twice.

A coating with a regular thickness of mean value 1.5 μm is obtained, having a roughness of 150 nm measured using a scanning electronic microscope MEB-FEG Jeol 7600F at 2 kV, 20 pA, WD (“Working Distance,” i.e. the distance between the head of measurement and the sample) 6 mm, in secondary electron mode.

The peak-to-valley distance measured by means of an interference profilometer is 350 nm.

The hydrophobicity of the inner wall of the PE tube is evaluated before formation of the coating and then after this formation resulting from the three cycles described above: for this purpose, the angle of advancement and recoil of a drop of water is measured. The angle of advancement is the contact angle of a drop measured with a goniometer during the growth of a drop produced by means of a pipette and a pre-pipette, for example, and the angle of recoil that of the decrease of a drop under the same conditions.

On the uncoated polyethylene, the angles of advancement and recoil are respectively 112° and 85° (hydrophobic behavior).

On the coated polyethylene they are both 155° (superhydrophobic behavior).

### Example 2

The inner wall of an extruded silicone tube, having a length of 1.5 m, an outer diameter of 9.6 mm and an inner diameter of 6.4 mm, is coated using a solution containing:
A 9:1 mix of THF and a dispersion containing
A 1:1 proportion of fumed silica (such as the AEROSIL R series, sold by the Evonik company), and a PDMS (such as the Sylgard series from Dow Corning) with a 10/1 ratio of PDMS/crosslinker.

The tube is in a vertical position.

The upper end of the tube is connected to a reservoir of the solution of coating particles in suspension by means of a valve; the speed of movement of the liquid in the tube is constantly 20 cm/s. After passage of an amount of liquid through the tube, the latter is left at 70° C. for 2 hours.

The resulting inner wall of the tube shows a superhydrophobic behaviour.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

1. A cylindrical tube made of polymer material or glass comprising a cylindrical inner wall that is constituted by a coating of hydrophobic particles having a surface with a peak-to-valley distance of between 100 nm and 50 μm, such as between 0.3 and 20 μm.

2. The tube of claim 1, characterized in that the inside diameter of the tube is at most equal to 10 cm, such as 5 cm, such as 20 mm, such as 10 mm, or even 4 mm.

3. The tube of claim 1, characterized in that the internal diameter of the tube is at least equal to 1 mm.

4. The tube of claim 1, characterized in that the coating of hydrophobic particles has a thickness of at least 300 nm.

5. The tube of claim 1, characterized in that the hydrophobic particles comprise metal oxide particles such as silica bearing a hydrophobic coating, hydrophobic polymer particles such as fluoropolymer, polysiloxane, polystyrene, polyester, silicone copolymer, thermoplastic silicone vulcanizate, copolyester, polyamide, polyethylene, polypropylene, polyether-ester copolymer, thermoplastic polyurethane, polyether amide block copolymer, polyamide block copolymer, styrene block copolymer, polycarbonate, polyolefin elastomer, thermoplastic vulcanizate, ionomer, polyoxymethylene (POM), acrylonitrile butadiene styrene (ABS), acetal, acrylic, polyvinyl chloride (PVC) or a combination thereof.

6. The tube of claim 5, wherein the hydrophobic particles comprise silica bearing a hydrophobic coating.

7. The tube of claim 1, characterized in that the hydrophobic coating particles have a size of between 5 nm and 10 μm, such as between 500 nm and 5 μm.

8. The tube of claim 1, characterized in that the coating particles have a mono- or polydispersed size distribution.

9. The tube of claim 1, characterized in that the inner wall has a contact angle with water of at least 135, such as 150°.

10. A process for manufacturing a cylindrical tube made of polymer material or glass, as claimed in claim 1, by forming a coating on the inner wall of the tube, comprising the steps of
displacing a segment of a liquid composition of suspended coating particles within the tube at a constant controlled velocity of at least 2 cm/sec so as to drive a homogeneous liquid film on the inner wall of the tube,
letting the solvent of the liquid composition evaporate and the suspended coating particles deposit on the inner wall of the tube, and
optionally, repeating the two previous steps at least once.

11. The process of claim 10, characterized in that, in order to let the solvent of the liquid composition evaporate and the suspension particles be deposited on the inner wall of the tube, the tube is allowed to stand at room temperature for at least one hour.

12. The process of claim 10, characterized in that the static contact angle of a drop of the liquid composition of suspended coating particles on the inner wall of the tube is at most equal to 20°.

13. The process of claim 10, characterized in that said two preceding operations are repeated until the thickness of the coating is at least equal to 300 nm, or the coating has a peak-to-valley distance between 100 nm and 50 μm.

14. The process of claim 10, characterized in that said two preceding operations are repeated twice.

15. The process of claim 10, characterized in that the displacement velocity of the liquid segment is at least equal to 5 cm/s.

16. The process of claim 15, characterized in that the displacement velocity of the liquid segment is at least equal to 10 cm/s.

17. The process of claim 15, characterized in that the displacement velocity of the liquid segment is at most equal to 50 cm/s.

18. The process of claim 10, characterized in that, prior to the displacement of a segment of a liquid composition inside the tube, it is first subjected to a treatment to render its surface hydrophilic so that the contact angle of a drop of water is at most equal to 20°.

19. The process of claim 18, characterized in that, prior to the displacement of a segment of a liquid composition inside the tube, it is first subjected to a reduction of the pressure to a value at most equal to 10 mbar, and then to a plasma activation.

20. The process of claim 18, characterized in that, prior to the displacement of a segment of a liquid composition inside the tube, the latter is subjected to chemical activation.
